(19) United States
(12) Patent Application Publication
(10) Pub. No.: US 2017/0263196 A1
(43) Pub. Date: Sep. 14, 2017

(54) DRIVING METHODS OF FOUR-COLOR DISPLAYS AND THE DRIVING DEVICES THEREOF

(71) Applicant: Shenzhen China Star Optoelectronics Technology Co., Ltd., Shenzhen, Guangdong (CN)

(72) Inventor: Jhenwei HE, Shenzhen, Guangdong (CN)

(73) Assignee: Shenzhen China Star Optoelectronics Technology Co., Ltd., Shenzhen, Guangdong (CN)

(21) Appl. No.: 14/909,095

(22) PCT Filed: Sep. 10, 2015
(86) PCT No.: PCT/CN2015/089389

§ 371 Date: Jan. 29, 2016

(30) Foreign Application Priority Data
Aug. 21, 2015 (CN) 201510519207.4

(51) Int. Cl. G09G 3/36

(52) U.S. Cl. CPC G09G 3/3607; G09G 3/3614; G09G 2320/0666; G09G 2330/021; G09G 2300/0452; G09G 2320/0247

(57) ABSTRACT

The present disclosure discloses a driving method of four-color displays. The method includes: dividing a plurality of pixels in each of rows to obtain pixel sets, each of the pixels comprises sub-pixels of four different colors, and the pixel set comprises four adjacent sub-pixels of four different colors; and inputting signals having opposite polarity respectively to two sub-pixels within two adjacent pixel sets, and the two sub-pixels are arranged in corresponding locations, and inputting the signals having the same polarity to at least two sub-pixels within the same pixel set, and the two sub-pixels are adjacent to each other. In addition, a driving device of the four-color display is disclosed. With the configuration, the signals applied toward the sub-pixels of different colors do not incline to a specific polarity. Thus, when the images only have one single color, the display performance may not be affected due to the unbalanced polarity.

### CROSS REFERENCE

This application claims the priority of Chinese Patent Application No. 201510519207.4, entitled “Driving methods of four-color displays and the driving devices thereof”, filed on Aug. 21, 2015, the disclosure of which is incorporated herein by reference in its entirety.

### FIELD OF THE INVENTION

The present invention relates to an electronic technology field, and more particularly to a driving method of four-color displays and the driving device thereof.

### BACKGROUND OF THE INVENTION

Original colors of display device include RGB colors, that is, the white is composited by the red (R), the green (G), and the blue (B). However, as the LCD cannot emit the light itself, the colors are formed in the process: the light beams emitted from the backlight module pass through the color filters of three colors to form three colors, and the colors are mixed. This process may consume a great deal of power. In order to reduce the power consumption of the LCD, a four-colors display device, including white and the original three colors RGB, has been developed. By configuring the white sub-pixel, the transmission rate of the LCD may be greatly enhanced so as to reduce the power consumption.

With respect to conventional solution, the pixel structure of the RGBW sub-pixels are driven by positive, negative, positive, and negative (+−+−) method. As shown in FIG. 1, the pixel includes the RGBW sub-pixels, and the signals is applied in the sequence, i.e., positive, negative, positive, and negative (+−+−), from the left to right in a repeated manner. By adopting the above method, if the display image is a grayscale image, the polarity of the four color sub-pixels is balanced, and the polarity of the adjacent pixels is also balanced. Thus, the display panel may display the images normally. However, as shown in FIG. 2, when the image is red, each of the sub-pixels is red. As the polarity of each of the red sub-pixels is positive, the polarity between the adjacent pixels is not balanced. Thus, image flicker and sticking may happen, which affects the display performance.

### SUMMARY OF THE INVENTION

The technical issue that the embodiment of the present disclosure solves is to provide adriving method of four-color displays and the driving device thereof. With the configuration, the signals applied toward the sub-pixels of different colors do not incline to a specific polarity. Thus, when the images only having one single color, the display performance may not be affected due to the unbalanced positive/negative polarity applied to the sub-pixels of single color.

In one aspect, adriving method of four-color displays includes: dividing a plurality of pixels in each of rows to obtain pixel sets, each of the pixels includes sub-pixels of four different colors, and the pixel set includes four adjacent sub-pixels of four different colors; and inputting signals having opposite polarity respectively to two sub-pixels within two adjacent pixel sets, and the two sub-pixels are arranged in corresponding locations, and inputting the signals having the same polarity to at least two sub-pixels within the same pixel set, and the two sub-pixels are adjacent to each other.

Wherein the method further includes: inputting the signals having the same polarity respectively to two sub-pixels within adjacent pixel sets, and the two sub-pixels are arranged in corresponding locations.

Wherein the step of inputting signals having opposite polarity respectively to two sub-pixels within two adjacent pixel sets, and the two sub-pixels are arranged in corresponding locations and inputting the signals having the same polarity to at least two sub-pixels within the same pixel set, and the two sub-pixels are adjacent to each other further includes: inputting the signals having the same polarity to each of the sub-pixels within each of the pixel sets.

Wherein the polarity is positive or negative, and the step of inputting the signals having the same polarity to each of the sub-pixels within each of the pixel sets further includes: with respect to two adjacent pixel sets, inputting the signals having the positive polarity to each of the sub-pixels within one pixel set, and inputting the signals having the negative polarity to each of the sub-pixels within the other pixel set.

Wherein each of the pixels is arranged as an array.

In another aspect, a driving device of four-color displays includes: a grouping module is configured for dividing a plurality of pixels in each of rows to obtain pixel sets, wherein each of the pixels includes sub-pixels of four different colors, and the pixel set includes four adjacent sub-pixels of four different colors; an input module is configured for inputting the signals having opposite polarity respectively to two sub-pixels within two adjacent pixel sets, and the two sub-pixels are arranged in corresponding locations, and for inputting the signals having the same polarity to the at least two sub-pixels within the same pixel set, and the two sub-pixels are adjacent to each other.

Wherein the input module inputs the signals having the same polarity respectively to two sub-pixels within adjacent pixel sets, and the two sub-pixels are arranged in corresponding locations.

Wherein the input module inputs the signals having the same polarity to each of the sub-pixels within each of the pixel sets.

Wherein with respect to two adjacent pixel sets, the input modules inputs the signals having the positive polarity to each of the sub-pixels within one pixel set, and inputs the signals having the negative polarity to each of the sub-pixels within the other pixel set.

Wherein each of the pixels is arranged as an array.

In view of the above, within the same frame, a plurality of pixels in each of rows is divided to pixel sets. Each of the pixels includes the sub-pixels of four different colors. The pixel set includes four sub-pixels in four different colors. The signals having opposite polarity are respectively inputted to two sub-pixels within adjacent pixel sets, and the two sub-pixels are arranged in corresponding locations. In addition, the signals having the same polarity are inputted to the at least two sub-pixels within the same pixel set, and the two sub-pixels are adjacent to each other. Within the same frame, the polarity of the signals applied to the basic unit, i.e., pixel sets, of each of the rows may be balanced. The signals applied toward the sub-pixels of different colors do not incline to a specific polarity. When the images only having one single color, the display performance may not be affected due to the unbalanced positive/negative polarity applied to the sub-pixels of single color.

### BRIEF DESCRIPTION OF THE DRAWINGS

In order to more clearly illustrate the embodiments of the present disclosure or prior art, the following figures will be described in the embodiments are briefly introduced. It is obvious that the drawings are merely some embodiments of the present disclosure, those of ordinary skill in this field can obtain other figures according to these figures without paying the premise.

FIG. 1 is a schematic view of the signals applied to each of the pixels of the conventional display panel.

FIG. 2 is a schematic view showing the pixel areas displaying a red image of the conventional display panel.

FIG. 3 is a flowchart of the driving method of the four-color display in accordance with one embodiment.

FIG. 4A is a schematic view of the first configuration of the signals applied to the pixel sets in accordance with one embodiment.

FIG. 4B is a schematic view of the pixel area of the first configuration in accordance with one embodiment.

FIG. 5A is a schematic view of the second configuration of the signals applied to the pixel sets in accordance with one embodiment.

FIG. 5B is a schematic view of the pixel area of the second configuration in accordance with one embodiment.

FIG. 6A is a schematic view of the third configuration of the signals applied to the pixel sets in accordance with one embodiment.

FIG. 6B is a schematic view of the pixel area of the third configuration in accordance with one embodiment.

FIG. 7 is a flowchart of the driving method of the four-color display in accordance with another embodiment.

FIG. 8A is a schematic view of the fourth configuration of the signals applied to the pixel sets in accordance with one embodiment.

FIG. 8B is a schematic view of the pixel area of the fourth configuration in accordance with one embodiment.

FIG. 8C is a schematic view of the pixel area of the fifth configuration in accordance with one embodiment.

FIG. 9 is a schematic view of the four-color display driving device in accordance with one embodiment.

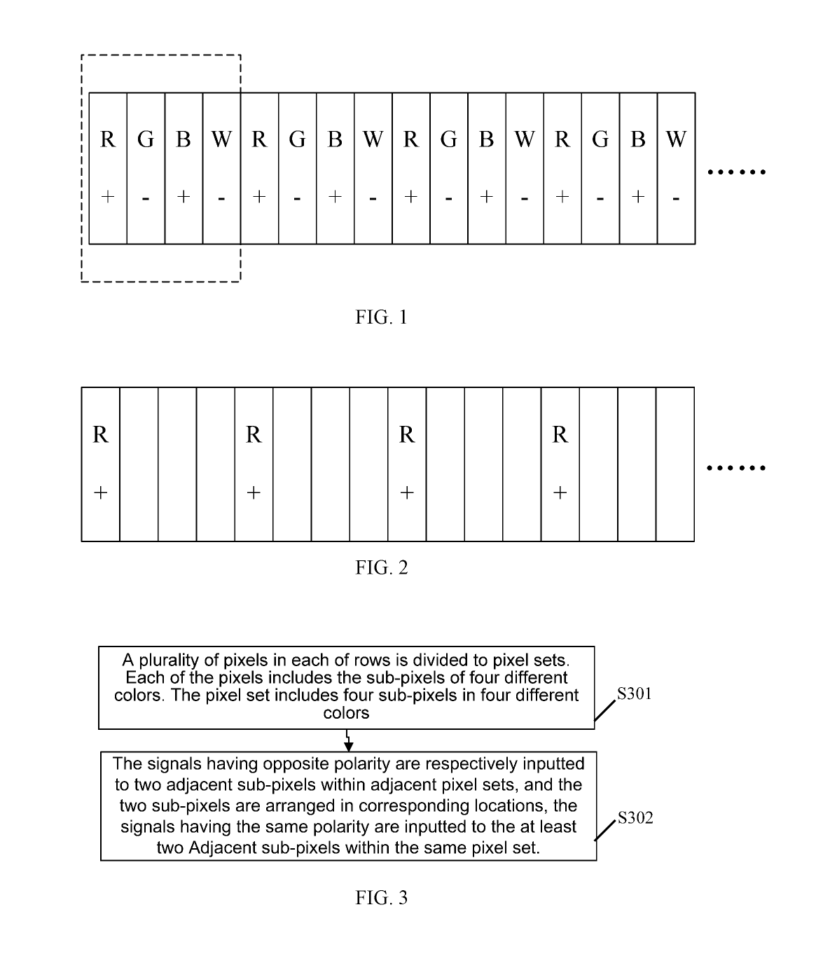

### DETAILED DESCRIPTION OF PREFERRED EMBODIMENTS

Embodiments of the present disclosure are described in detail with the technical matters, structural features, achieved objects, and effects with reference to the accompanying drawings as follows. It is clear that the described embodiments are part of embodiments of the present disclosure, but not all embodiments. Based on the embodiments of the present disclosure, all other embodiments to those of ordinary skill in the premise of no creative efforts obtained, should be considered within the scope of protection of the present disclosure.

FIG. 3 is a flowchart of the driving method of the four-color display in accordance with one embodiment. The method includes the following steps.

In step S301, a plurality of pixels in each of rows is divided to pixel sets. Each of the pixels includes the sub-pixels of four different colors. The pixel set includes four sub-pixels in four different colors.

Specifically, the pixel of the display panel is formed by the sub-pixels in four different colors. Each of the pixels is arranged as an array. Each pixel set includes four sub-pixels in four different colors. For instance, each of the pixels respectively includes sub-pixels of red (R), green (G), blue (B), and white (W). The pixels in the rows are divided such that four adjacent sub-pixels are in the same set. Each of the pixel sets includes the sub-pixels of red (R), green (G), blue (B), and white (W).

In block S302, the signals having opposite polarity are respectively inputted to two sub-pixels within adjacent pixel sets, and the two sub-pixels are arranged in corresponding locations. In addition, the signals having the same polarity are inputted to the at least two sub-pixels within the same pixel set, and the two sub-pixels are adjacent to each other.

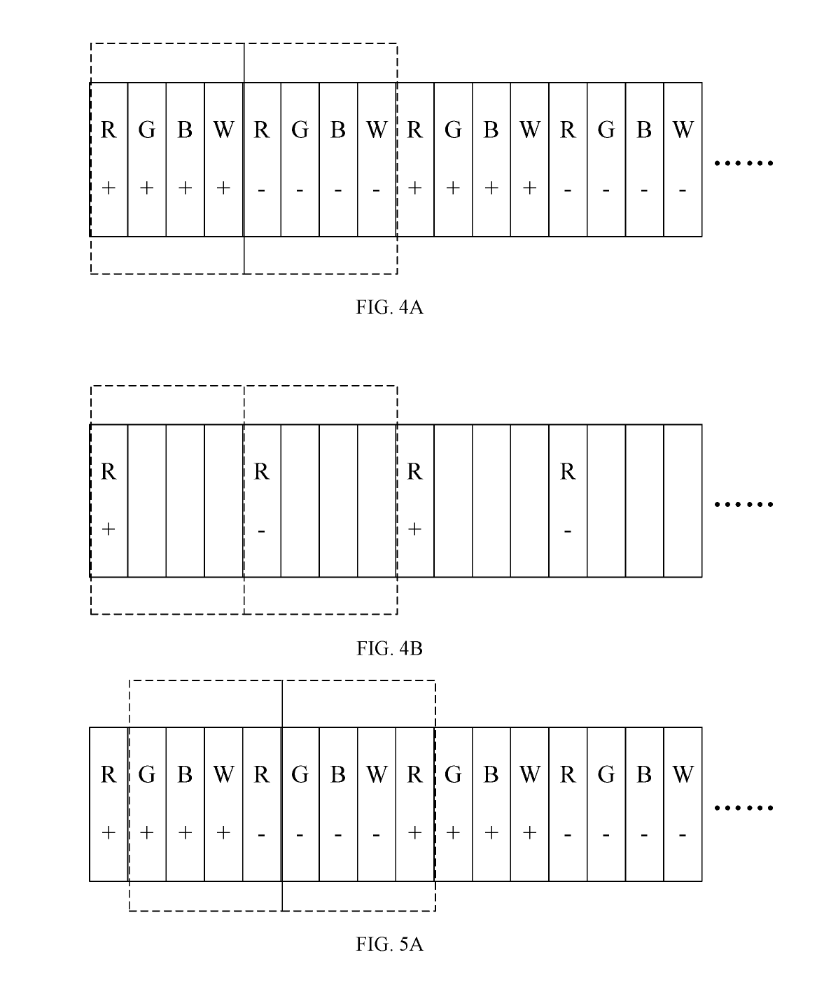

Specifically, the signals of the same polarity are inputted to the sub-pixels within the same pixel set. The signals having the polarity sequence, i.e., (++++, −−−−), are respectively inputted to the two adjacent pixel sets. As shown in FIG. 4B, when the image to be displayed is of red, the polarity of the two red sub-pixels within the two adjacent pixel sets are respectively positive and negative, and thus the polarity of the pixel sets is balanced.

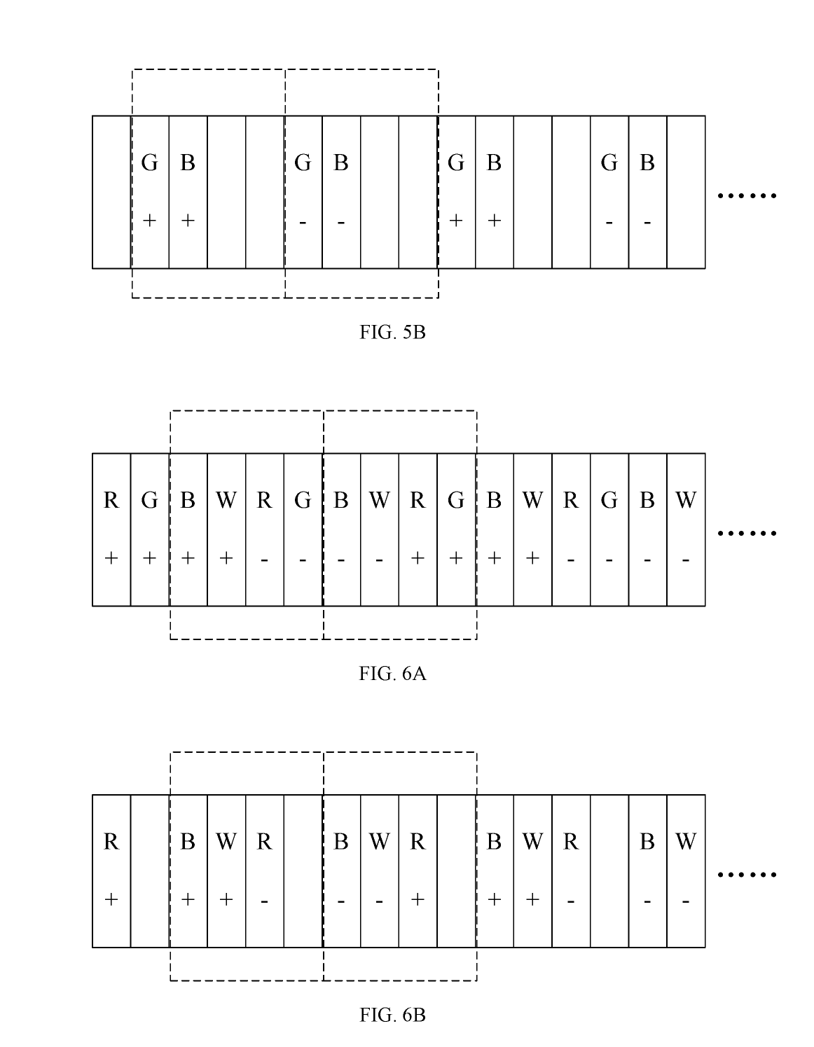

Alternatively, the signals of the same polarity are inputted to the three adjacent sub-pixels within the same pixel set. As shown in FIG. 5A, the signals having the polarity sequences(+++−, −−−+) are respectively inputted to the two adjacent pixel sets. As shown in FIG. 5B, when the image to be displayed is of green and blue, the green sub-pixel and the blue sub-pixel in one of the pixel sets are of the positive polarity, and the green sub-pixel and the blue sub-pixel in the other pixel set are of the negative polarity. Thus, the polarity of the pixel sets within the row is balanced.

Alternatively, the signals of the same polarity are inputted to the two adjacent sub-pixels within the same pixel set. As shown in FIG. 6A, the signals having the polarity sequences (++−−, −−30 +) are respectively inputted to the two adjacent pixel sets. As shown in FIG. 6B, when the image to be displayed is of blue, white, and red, the polarity sequence of the blue sub-pixel, white sub-pixel, and the red sub-pixel in one of the pixel sets is shown as positive, positive, and negative. The polarity sequence of the blue sub-pixel, white sub-pixel, and the red sub-pixel in the other pixel set is shown as negative, negative, and positive. Thus, the polarity of the pixel sets within the row is balanced.

In the embodiment, within a frame, the pixels in each of the rows are divided to pixel sets. The pixel of the display panel is formed by the sub-pixels in four different colors. Each pixel set includes four sub-pixels in four different colors.

The signals having opposite polarity are respectively inputted to two sub-pixels within adjacent pixel sets, and the two sub-pixels are arranged in corresponding locations. The signals having the same polarity are inputted to the at least two sub-pixels within the same pixel set, and the two sub-pixels are adjacent to each other. Thus, within the same frame, the polarity of the signals applied to the basic unit, i.e., pixel sets, of each of the rows may be balanced. The signals applied toward the sub-pixels of different colors do not incline to a specific polarity. When the images only having one single color, the display performance may not be affected due to the unbalanced positive/negative polarity applied to the sub-pixels of single color.

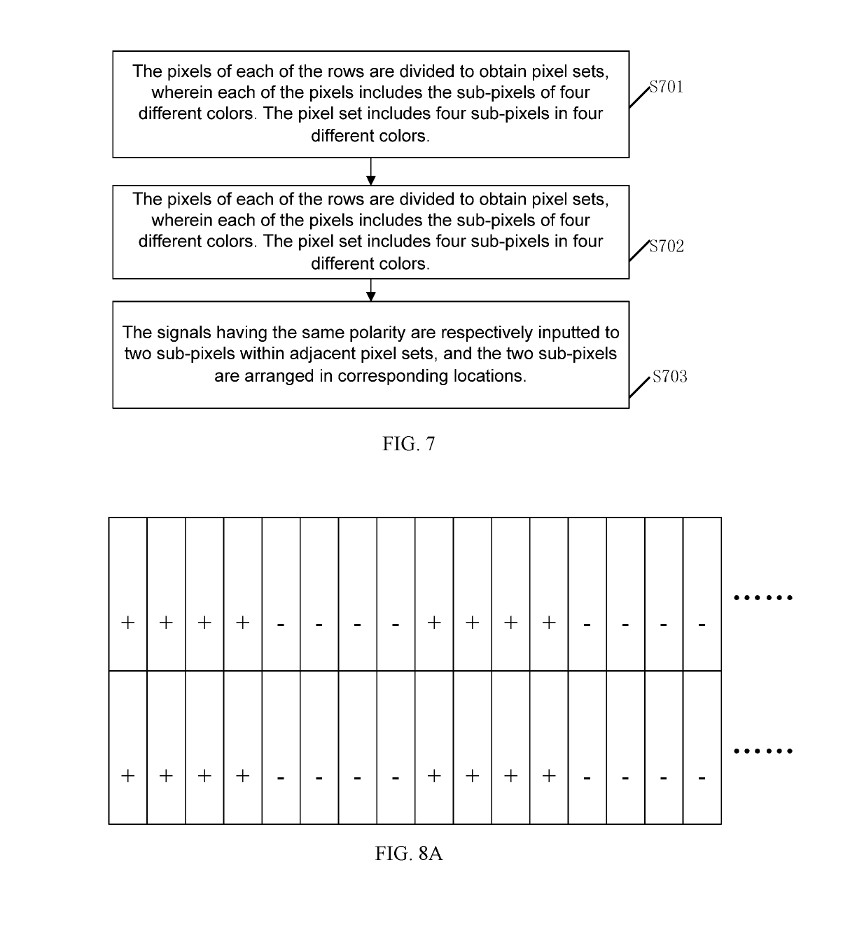

FIG. 7 is a flowchart of the driving method of the four-color display in accordance with another embodiment. The method includes the following steps.

In step S701, the pixels of each of the rows are divided to obtain pixel sets, wherein each of the pixels includes the sub-pixels of four different colors. The pixel set includes four sub-pixels in four different colors.

Specifically, the pixel of the display panel is formed by the sub-pixels in four different colors. Each of the pixels is arranged as an array. Each pixel set includes four sub-pixels in four different colors. For instance, each of the pixels respectively includes sub-pixels of red (R), green (G), blue (B), and white (W). The pixels in the rows are divided such that four adjacent sub-pixels are in the same set. Each of the pixel sets includes the sub-pixels of red (R), green (G), blue (B), and white (W).

In step S702, the signals having opposite polarity are respectively inputted to two sub-pixels within adjacent pixel sets, and the two sub-pixels are arranged in corresponding locations. In addition, the signals having the same polarity are inputted to the at least two sub-pixels within the same pixel set, and the two sub-pixels are adjacent to each other.

Specifically, the signals of the same polarity are inputted to the sub-pixels within the same pixel set. The signals of the positive polarity and of the negative polarity, i.e., (++++, −−−−), are respectively inputted to the two adjacent pixel sets. As shown in FIG. 4B, when the image to be displayed is of red, the polarity of the two red sub-pixels within the two adjacent pixel sets are respectively positive and negative, and thus the polarity of the pixel sets is balanced.

Alternatively, the signals of the same polarity are inputted to the three adjacent sub-pixels within the same pixel set. As shown in FIG. 5A, the signals having the polarity sequences (+++−, −−−+) are respectively inputted to the two adjacent pixel sets. As shown in FIG. 5B, when the image to be displayed is of green and blue, the green sub-pixel and the blue sub-pixel in one of the pixel sets are of the positive polarity, and the green sub-pixel and the blue sub-pixel in the other pixel set are of the negative polarity. Thus, the polarity of the pixel sets within the row is balanced.

Alternatively, the signals of the same polarity are inputted to the three adjacent sub-pixels within the same pixel set. As shown in FIG. 5A, the signals having the polarity sequences (+++−, −−−+) are respectively inputted to the two adjacent pixel sets. As shown in FIG. 5B, when the image to be displayed is of green and blue, the green sub-pixel and the blue sub-pixel in one of the pixel sets are of the positive polarity, and the green sub-pixel and the blue sub-pixel in the other pixel set are of the negative polarity. Thus, the polarity of the pixel sets within the row is balanced.

Alternatively, the signals of the same polarity are inputted to the two adjacent sub-pixels within the same pixel set. As shown in FIG. 6A, the signals having the polarity sequences (++−−, −−++) are respectively inputted to the two adjacent pixel sets. As shown in FIG. 6B, when the image to be displayed is of blue, white, and red, the polarity sequence of the blue sub-pixel, white sub-pixel, and the red sub-pixel in one of the pixel sets is shown as positive, positive, and negative. The polarity sequence of the blue sub-pixel, white sub-pixel, and the red sub-pixel in the other pixel set is shown as negative, negative, and positive. Thus, the polarity of the pixel sets within the row is balanced.

In step S703, the signals having the same polarity are respectively inputted to two sub-pixels within adjacent pixel sets, and the two sub-pixels are arranged in corresponding locations.

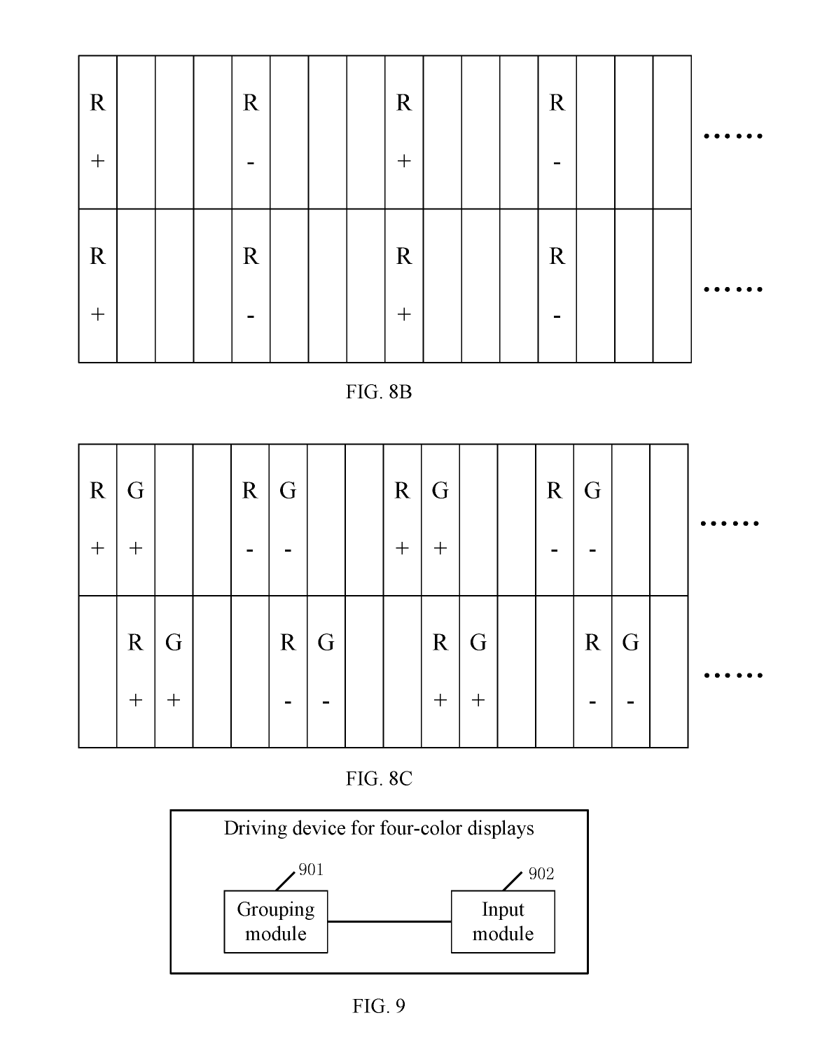

Specifically, as shown in FIG. 8A, the signals having the polarity sequence, i.e., (++++), are inputted to the sub-pixels within one pixel set of the first row, and the signals having the polarity sequence, i.e., (++++), are also inputted to the sub-pixels within the corresponding pixel set of the second row. As shown in FIG. 8B, if the image to be displayed is of red, the polarity sequence of the red sub-pixels along the row is shown as (+−+− . . . ). Thus, the polarity of the pixel sets along the row is balanced. As shown in FIG. 8C, if the image to be displayed is of red and green, the polarity of the red and green sub-pixels in the first pixel set of the first row and the polarity of the red and green sub-pixels in the first pixel set of the second row are positive, and the polarity of the red and green sub-pixels in the second pixel set of the first row and the polarity of the red and green sub-pixels in the second pixel set of the second row are negative. The polarity of the red and green sub-pixels of other rows may be conceived in the same way. Thus, the polarity of the pixel sets along the column direction is balanced.

In view of the above, within the same frame, a plurality of pixels in each of rows is divided to pixel sets. Each of the pixels includes the sub-pixels of four different colors. The pixel set includes four sub-pixels in four different colors. The signals having opposite polarity are respectively inputted to two sub-pixels within adjacent pixel sets, and the two sub-pixels are arranged in corresponding locations. In addition, the signals having the same polarity are inputted to the at least two sub-pixels within the same pixel set, and the two sub-pixels are adjacent to each other. Within the same frame, the polarity of the signals applied to the basic unit, i.e., pixel sets, of each of the rows may be balanced. The signals applied toward the sub-pixels of different colors do not incline to a specific polarity. When the images only having one single color, the display performance may not be affected due to the unbalanced positive/negative polarity applied to the sub-pixels of single color.

FIG. 9 is a schematic view of the four-color driving device in accordance with one embodiment. The driving device includes:

A grouping module 901 is configured for dividing a plurality of pixels in each of rows to obtain pixel sets. Each of the pixels includes the sub-pixels of four different colors. The pixel set includes four adjacent sub-pixels of four different colors.

Specifically, the pixel of the display panel is formed by the sub-pixels in four different colors. Each of the pixels is arranged as an array. Each pixel set includes four sub-pixels in four different colors. For instance, each of the pixels respectively includes sub-pixels of red (R), green (G), blue (B), and white (W). The pixels in the rows are divided such that four adjacent sub-pixels are in the same set. Each of the pixel sets includes the sub-pixels of red (R), green (G), blue (B), and white (W).

An input module 902 is configured for inputting the signals having opposite polarity respectively to two sub-pixels within two adjacent pixel sets, and the two sub-pixels are arranged in corresponding locations. The input module 902 is configured for inputting the signals having the same polarity to the at least two sub-pixels within the same pixel set, and the two sub-pixels are adjacent to each other.

Specifically, the signals of the same polarity are inputted to the sub-pixels within the same pixel set. The signals having the polarity sequence, i.e., (++++, −−−−), are respectively inputted to the two adjacent pixel sets. As shown in FIG. 4B, when the image to be displayed is of red, the polarity of the two red sub-pixels within the two adjacent pixel sets are respectively positive and negative, and thus the polarity of the pixel sets is balanced.

Alternatively, the signals of the same polarity are inputted to the three adjacent sub-pixels within the same pixel set. As shown in FIG. 5A, the signals having the polarity sequences (+++−, −−−+) are respectively inputted to the two adjacent pixel sets. As shown in FIG. 5B, when the image to be displayed is of green and blue, the green sub-pixel and the blue sub-pixel in one of the pixel sets are of the positive polarity, and the green sub-pixel and the blue sub-pixel in the other pixel set are of the negative polarity. Thus, the polarity of the pixel sets within the row is balanced.

Alternatively, the signals of the same polarity are inputted to the two adjacent sub-pixels within the same pixel set. As shown in FIG. 6A, the signals having the polarity sequences (++−−, −−++) are respectively inputted to the two adjacent pixel sets. As shown in FIG. 6B, when the image to be displayed is of blue, white, and red, the polarity sequence of the blue sub-pixel, white sub-pixel, and the red sub-pixel in one of the pixel sets is shown as positive, positive, and negative. The polarity sequence of the blue sub-pixel, white sub-pixel, and the red sub-pixel in the other pixel set is shown as negative, negative, and positive. Thus, the polarity of the pixel sets within the row is balanced.

Alternatively, the input module 902 is configured for inputting the signals having the same polarity respectively to two sub-pixels within adjacent pixel sets, and the two sub-pixels are arranged in corresponding locations.

Specifically, as shown in FIG. 8A, the signals having the polarity sequence, i.e., (++++), are inputted to the sub-pixels within one pixel set of the first row, and the signals having the polarity sequence, i.e., (++++), are also inputted to the sub-pixels within the corresponding pixel set of the second row. As shown in FIG. 8B, if the image to be displayed is of red, the polarity sequence of the red sub-pixels along the row is shown as (+−+− . . . ). Thus, the polarity of the pixel sets along the row is balanced. As shown in FIG. 8C, if the image to be displayed is of red and green, the polarity of the red and green sub-pixels in the first pixel set of the first row and the polarity of the red and green sub-pixels in the first pixel set of the second row are positive, and the polarity of the red and green sub-pixels in the second pixel set of the first row and the polarity of the red and green sub-pixels in the second pixel set of the second row are negative. The polarity of the red and green sub-pixels of other rows may be conceived in the same way. Thus, the polarity of the pixel sets along the column direction is balanced.

In view of the above, within the same frame, a plurality of pixels in each of rows is divided to pixel sets. Each of the pixels includes the sub-pixels of four different colors. The pixel set includes four sub-pixels in four different colors. The signals having opposite polarity are respectively inputted to two sub-pixels within adjacent pixel sets, and the two sub-pixels are arranged in corresponding locations. In addition, the signals having the same polarity are inputted to the at least two sub-pixels within the same pixel set, and the two sub-pixels are adjacent to each other. Within the same frame, the polarity of the signals applied to the basic unit, i.e., pixel sets, of each of the rows may be balanced. The signals applied toward the sub-pixels of different colors do not incline to a specific polarity. When the images only having one single color, the display performance may not be affected due to the unbalanced positive/negative polarity applied to the sub-pixels of single color.

Above are embodiments of the present disclosure, which does not limit the scope of the present disclosure. Any modifications, equivalent replacements or improvements within the spirit and principles of the embodiment described above should be covered by the protected scope of the disclosure.

What is claimed is:

1. A driving method of four-color displays, comprising:
dividing a plurality of pixels in each of rows to obtain pixel sets, each of the pixels comprises sub-pixels of four different colors, and the pixel set comprises four adjacent sub-pixels of four different colors; and
inputting signals having opposite polarity respectively to two sub-pixels within two adjacent pixel sets, and the two sub-pixels are arranged in corresponding locations, and inputting the signals having the same polarity to at least two sub-pixels within the same pixel set, and the two sub-pixels are adjacent to each other.

2. The method as claimed in claim 1, wherein the method further comprises:
inputting the signals having the same polarity respectively to two sub-pixels within adjacent pixel sets, and the two sub-pixels are arranged in corresponding locations.

3. The method as claimed in claim 1, wherein the step of inputting signals having opposite polarity respectively to two sub-pixels within two adjacent pixel sets, and the two sub-pixels are arranged in corresponding locations and inputting the signals having the same polarity to at least two sub-pixels within the same pixel set, and the two sub-pixels are adjacent to each other further comprises:
inputting the signals having the same polarity to each of the sub-pixels within each of the pixel sets.

4. The method as claimed in claim 3, wherein the polarity is positive or negative, and the step of inputting the signals having the same polarity to each of the sub-pixels within each of the pixel sets further comprises:
with respect to two adjacent pixel sets, inputting the signals having the positive polarity to each of the sub-pixels within one pixel set, and inputting the signals having the negative polarity to each of the sub-pixels within the other pixel set.

5. The method as claimed in claim 1, wherein each of the pixels is arranged as an array.

6. The method as claimed in claim 2, wherein each of the pixels is arranged as an array.

7. The method as claimed in claim 3, wherein each of the pixels is arranged as an array.

8. The method as claimed in claim 4, wherein each of the pixels is arranged as an array.

9. A driving device of four-color displays, comprising:
a grouping module is configured for dividing a plurality of pixels in each of rows to obtain pixel sets, wherein each of the pixels comprises sub-pixels of four different colors, and the pixel set comprises four adjacent sub-pixels of four different colors; and
an input module is configured for inputting the signals having opposite polarity respectively to two sub-pixels within two adjacent pixel sets, and the two sub-pixels are arranged in corresponding locations, and for inputting the signals having the same polarity to the at least two sub-pixels within the same pixel set, and the two sub-pixels are adjacent to each other.

10. The device as claimed in claim 9, wherein the input module inputs the signals having the same polarity respectively to two sub-pixels within adjacent pixel sets, and the two sub-pixels are arranged in corresponding locations.

11. The device as claimed in claim 9, wherein the input module inputs the signals having the same polarity to each of the sub-pixels within each of the pixel sets.

12. The device as claimed in claim 11, wherein with respect to two adjacent pixel sets, the input modules inputs the signals having the positive polarity to each of the sub-pixels within one pixel set, and inputs the signals having the negative polarity to each of the sub-pixels within the other pixel set.

13. The device as claimed in claim 9, wherein each of the pixels is arranged as an array.

14. The device as claimed in claim 10, wherein each of the pixels is arranged as an array.

15. The device as claimed in claim 11, wherein each of the pixels is arranged as an array.

16. The device as claimed in claim 12, wherein each of the pixels is arranged as an array.
